(19) United States
(12) Patent Application Publication
(10) Pub. No.: US 2024/0308858 A1
(43) Pub. Date: Sep. 19, 2024

(54) HOLLOW SILICA PARTICLES AND METHOD FOR PRODUCING SAME

(71) Applicants: AGC Inc., Tokyo (JP); AGC SI-TECH CO., LTD., Kitakyushu-shi (JP)

(72) Inventors: Hiromichi KAMO, Tokyo (JP); Hajime KATAYAMA, Tokyo (JP)

(73) Assignees: AGC Inc., Tokyo (JP); AGC SI-TECH CO., LTD., Kitakyushu-shi (JP)

(21) Appl. No.: 18/675,502

(22) Filed: May 28, 2024

Related U.S. Application Data
(63) Continuation of application No. PCT/JP2022/042755, filed on Nov. 17, 2022.

(30) Foreign Application Priority Data
Nov. 30, 2021 (JP) 2021-194371

(51) Int. Cl. C01B 33/12; C08K 3/36

(52) U.S. Cl. CPC C01B 33/12; C08K 3/36; C01P 2002/86; C01P 2004/03; C01P 2004/34; C01P 2004/61; C01P 2004/62; C01P 2004/64; C01P 2006/10; C01P 2006/12; C01P 2006/40

(57) ABSTRACT

The present invention relates to hollow silica particles each including a shell layer that includes silica and having a space portion inside the shell layer, in which when A (g/cm³) is a particle density determined by density measurement with a dry pycnometer using argon gas and B (m²/g) is a BET specific surface area, the hollow silica particles have a product (A×B) of the particle density and the BET specific surface area of 1 m²/cm³ to 120 m²/cm³.

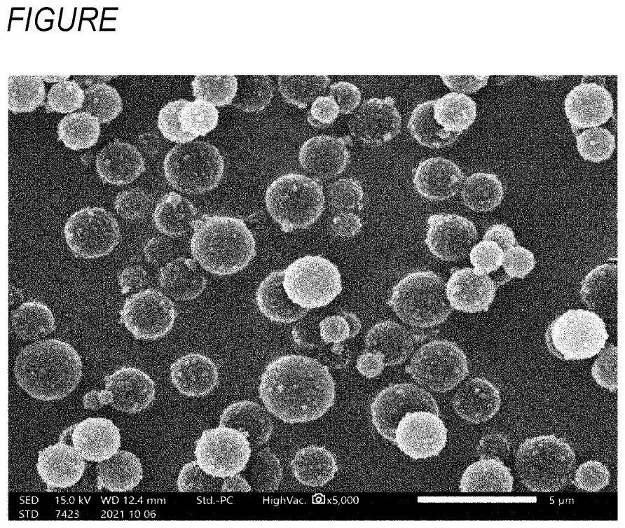

### CROSS-REFERENCE TO RELATED APPLICATIONS

This is a continuation of International Application No. PCT/JP2022/042755 filed on Nov. 17, 2022, and claims priority from Japanese Patent Application No. 2021-194371 filed on Nov. 30, 2021, the entire content of which is incorporated herein by reference.

### TECHNICAL FIELD

The present invention relates to hollow silica particles and a method for producing the same.

### BACKGROUND ART

In recent years, miniaturization of electronic devices, high speed of signals, and densification of wiring are required. In order to satisfy the requirements, it is required that an insulating resin sheet, such as an adhesive film or a prepreg, and a resin composition used in an insulating layer formed on a printed wiring board are made to achieve a low relative permittivity, a low dielectric loss tangent, and a low thermal expansion.

In order to satisfy these requirements, studies using hollow particles as fillers have been conducted, and various proposals have been made. For example, Patent Literature 1 describes a resin composition including (A) an epoxy resin, (B) a curing agent, (C) hollow silica, and (D) fused silica. Patent Literature 2 describes a low dielectric resin composition including hollow particles and a thermosetting resin, in which. in the hollow particles, 98 mass % or more of an entire shell is formed of silica, and the hollow particles have an average porosity of 30% by volume to 80% by volume and an average particle diameter of 0.1 μm to 20 μm.

In addition, various proposals have been made for hollow silica materials used as low-relative-permittivity materials. For example, Patent Literature 3 proposes a hollow silica material having a closed cavity structure having a shell with pores, a cavity volume ratio of 0% to 86%, a relative permittivity of 1.5 to 3.3, a relative permittivity of 1.5 to 3.3 for flowing in a frequency band of 20 to 43.5 GHz, and a dielectric loss angle tangent of 0.0005 to 0.004.

### CITATION LIST

### Patent Literature

Patent Literature 1: JP2013-173841A

Patent Literature 2: JP2008-031409A

Patent Literature 3: CN111232993A

### SUMMARY OF INVENTION

### Technical Problem

However, regarding hollow silica particles in the related art, when the hollow silica particles are added to a solvent, the solvent may permeate into the particles, and the intended use may not be possible. For example, when the hollow silica particles are added to methyl ethyl ketone, a viscosity of a composition is increased due to impregnation of the particles with methyl ethyl ketone, an addition amount of the hollow silica particles is not increased, and a sufficiently low relative permittivity cannot be achieved.

In addition, in the hollow silica material described in Patent Literature 3, in the examples, after an inorganic compound of a template is coated with silica and the template is removed, silica sol is added and aged to obtain hollow silica particles. However, in the method, the inorganic compound of the template tends to aggregate, and there is a problem that the aggregation of primary particles and an aggregation diameter cannot be controlled. The aggregation of the primary particles tends to become a defect of a shell of hollow silica, and a resin varnish is contained therein, so that dispersibility tends to deteriorate. Further, there are problems in that it is difficult to control the dispersion of the template and a secondary particle diameter is likely to increase.

The present invention has been made in view of the above problems, and an object of the present invention is to provide novel hollow silica particles having a sufficiently small relative permittivity and dielectric loss tangent, and excellent dispersibility in a resin.

### Solution to Problem

The present invention relates to the following (1) to (18).
(1) Hollow silica particles each including a shell layer that includes silica and having a space portion inside the shell layer, in which when A (g/cm³) is a particle density determined by density measurement with a dry pycnometer using argon gas and B (m²/g) is a BET specific surface area, the hollow silica particles have a product (A×B) of the particle density and the BET specific surface area of 1 m²/cm³ to 120 m²/cm³.
(2) The hollow silica particles according to (1), having the particle density determined by density measurement with a dry pycnometer using argon gas of 0.35 g/cm³ to 2.00 g/cm³.
(3) The hollow silica particles according to (1) or (2), having a particle density determined by density measurement with a dry pycnometer using helium gas of 2.00 g/cm³ to 2.35 g/cm³.
(4) The hollow silica particles according to any one of (1) to (3), having an average primary particle diameter of 50 nm to 10 μm.
(5) The hollow silica particles according to any one of (1) to (4), in which 35% or more of all primary particles have a particle diameter within an average primary particle diameter±40%.
(6) The hollow silica particles according to any one of (1) to (5), having the BET specific surface area of 1 m²/g to 100 m²/g.
(7) The hollow silica particles according to any one of (1) to (6), having a sphericity of 0.75 to 1.0.
(8) The hollow silica particles according to any one of (1) to (7), having a median diameter (D50) of secondary particles of 0.1 μm to 10 μm.
(9) The hollow silica particles according to any one of (1) to (8), having a coarse particle diameter (D90) of secondary particles of 1 μm to 30 μm.
(10) The hollow silica particles according to any one of (1) to (9), including one or more kinds of metal M selected from the group consisting of Li, Na, K, Rb, Cs, Mg, Ca, Sr, and Ba, and having a total concentration of the metal M of 50 ppm by mass or more and 1 mass % or less.
(11) The hollow silica particles according to any one of (1) to (10), in which a viscosity of a kneaded product including the hollow silica particles as measured by the following measurement method is 10,000 mPa·s or less, the measurement method:
   a kneaded product obtained by mixing 6 parts by mass of a boiled linseed oil and (6×A/2.2) parts by mass of the hollow silica particles, where A (g/cm³) is a particle density determined by density measurement with a dry pycnometer using argon gas, and kneading a resulting mixture at 2,000 rpm for 3 minutes is measured for 30 seconds at a shear rate of 1 s⁻¹ using a rotary rheometer to determine a viscosity at 30 seconds.
(12) The hollow silica particles according to any one of (1) to (11), having a molar ratio (Q3/Q4) of a Q3 structure to a Q4 structure as measured by solid ²⁹Si-DD/MAS-NMR of 2% to 40%, the Q3 structure being a structure having one OH group derived from a silanol group and the Q4 structure being a structure having no OH group derived from the silanol group.
(13) A method for producing the hollow silica particles according to any one of (1) to (12), the method including: preparing an oil-in-water emulsion including an aqueous phase, an oil phase, and a surfactant; leaving the oil-in-water emulsion to stand for 0.5 hours to 240 hours to obtain a hollow silica precursor in which a shell layer including silica is formed on an outer periphery of a core in the oil-in-water emulsion; and removing the core from the hollow silica precursor, followed by performing a heat treatment.
(14) The method for producing hollow silica particles according to (13), the method further including: subjecting particles after the heat treatment to a surface treatment with a silane coupling agent.
(15) The method for producing hollow silica particles according to (13) or (14), the method further including: adding a silica raw material to the oil-in-water emulsion.
(16) The method for producing hollow silica particles according to (15), in which sodium silicate is used as a silica source.
(17) A resin composition including 5 mass % to 70 mass % of the hollow silica particles according to any one of (1) to (12).
(18) A slurry composition including 1 mass % to 40 mass % of the hollow silica particles according to any one of (1) to (12).

### Advantageous Effects of Invention

The hollow silica particles of the present invention include a dense shell layer and have a small specific surface area, and thus both a relative permittivity and dielectric loss tangent can be sufficiently reduced. The hollow silica particles of the present invention are difficult to be impregnated with a solvent such as methyl ethyl ketone or N-methylpyrrolidone, and thus can exhibit an excellent low relative permittivity and low dielectric loss tangent even in a resin composition. In addition, the hollow silica particles of the present invention have an appropriate specific surface area and are excellent in dispersibility in a resin.

### BRIEF DESCRIPTION OF DRAWINGS

The FIGURE shows a scanning electron microscopic image (SEM image) of hollow silica particles obtained in Example 1.

### DESCRIPTION OF EMBODIMENTS

The present invention will be described below, but the present invention is not limited to examples described below.

In the present specification, “mass” is synonymous with “weight”.

### Hollow Silica Particles

Hollow silica particles of the present invention each include a shell layer (solid film) that includes silica, and have a space portion inside the shell layer. The fact that the hollow silica particles each have a space portion inside the shell layer can be confirmed by transmission electron microscope (TEM) observation or scanning electron microscope (SEM) observation. In the case of SEM observation, by observing partially opened broken-particles, it can be confirmed that the particles are hollow. A spherical particle having a space portion inside, which can be confirmed by TEM observation or SEM observation, is defined as a “primary particle”. Since primary particles in the hollow silica particles are partially bonded to each other in a step of baking or drying, hollow silica particles obtained in the production are often aggregates of secondary particles in which the primary particles are aggregated.

In the present specification, the expression that the shell layer “includes silica” means that the shell layer includes 50 mass % or more of silica (SiO₂). A composition of the shell layer can be measured by ICP emission spectrometry or flame atomic absorption spectrometry. A content of the silica included in the shell layer is preferably 80 mass % or more, and more preferably 95 mass % or more. An upper limit thereof is theoretically 100 mass %. The content of the silica included in the shell layer is preferably less than 100 mass %, and more preferably 99.99 mass % or less. Examples of a remainder include alkali metal oxides and silicates, alkaline earth metal oxides and silicates, and carbon.

In addition, the expression “having a space portion inside a shell layer” means a hollow state in which the shell layer surrounds the periphery of one space portion when observing a cross section of one primary particle. That is, one hollow particle has one large space portion and a shell layer surrounding the space portion.

The hollow silica particles of the present invention have a structure having a space portion in a shell. Therefore, when the particles as a filler are added to a solvent, more spaces can be secured in the composition. Thus, when the hollow silica particles are used for an insulating layer of an electronic device or the like, a permittivity can be decreased.

In the hollow silica particles of the present invention, when A (g/cm³) is a particle density (hereinafter also referred to as Ar density) determined by density measurement with a dry pycnometer using argon gas and B (m²/g) is a BET specific surface area, a product (A×B) of the Ar density and the BET specific surface are is 1 m²/cm³ to 120 m²/cm³, A×B indicates a specific surface area per volume when the hollow silica particles are dispersed in a solvent. For example, when the hollow silica particles are added to a resin, A×B indicates a specific surface area of a portion occupied by the hollow silica particles in a predetermined volume in the resin. Since the Ar density and the BET specific surface area of the particles satisfy the above relation, when a resin composition including the hollow silica particles of the present invention is used for an insulating layer, a permittivity of the insulating layer can be decreased, and a dielectric loss can be decreased. Therefore, it is possible to provide a substrate that can sufficiently cope with a high-frequency circuit. When A×B is 120 m²/cm³ or less, the specific surface area of silica in the solvent is small, and thus a viscosity of the composition does not excessively increase. When the viscosity of the composition excessively increases, dielectric loss tangent may deteriorate, but when the viscosity of the composition is 120 m²/cm³ or less, the deterioration of the dielectric loss tangent can be prevented. A×B is preferably 80 m²/cm³ or less, more preferably 40 m²/cm³ or less, and still more preferably 20 m²/cm³ or less. In addition, it is substantially difficult to produce particles in which A×B is smaller than the above range. A×B is preferably 2 m²/cm³ or more, more preferably 2.5 m²/cm³ or more, and still more preferably 3 m²/cm³ or more.

In the hollow silica particles of the present invention, the particle density (Ar density) determined by density measurement with a dry pycnometer using argon gas is preferably 0.35 g/cm³ to 2.00 g/cm³. When the Ar density is 0.35 g/cm³ or more, a difference in specific gravity from, for example, the resin does not excessively increase, and thus dispersibility in the resin composition can be improved. When the Ar density is 2.00 g/cm³ or less, an effect of reducing the permittivity is easily exhibited. A lower limit of the Ar density is more preferably 0.40 g/cm³ or more, and an upper limit thereof is more preferably 1.50 g/cm³ or less, and still more preferably 1.00 g/cm³ or less. Specifically, the Ar density is more preferably 0.35 g/cm³ to 1.50 g/cm³, and still more preferably 0.40 g/cm³ to 1.00 g/cm³.

In the hollow silica particles of the present invention, a particle density (hereinafter also referred to as He density) determined by density measurement with a dry pycnometer using helium gas is preferably 2.00 g/cm³ to 2.35 g/cm³. Since the helium gas permeates through fine voids, a density of silica particles having a space inside is acquired, the density corresponding to a true density of a silica portion. When the He density is 2.00 g/cm³ or more, a residual amount of silanol contained in the hollow silica particles decreases, and thus the dielectric loss tangent is easily decreased. In order to obtain a siliceous substance having a He density exceeding 2.35 g/cm³, baking at a considerably high temperature is necessary, and the particles are easily broken. When the He density is 2.35 g/cm³ or less, the space contained in the hollow silica particles can be maintained, and the Ar density does not deteriorate. A lower limit of the He density is more preferably 2.05 g/cm³ or more, and still more preferably 2.10 g/cm³ or more. An upper limit thereof is more preferably 2.33 g/cm³ or less, and still more preferably 2.30 g/cm³ or less. Specifically, the He density is more preferably 2.05 g/cm³ to 2.35 g/cm³, and still more preferably 2.10 g/cm³ to 2.33 g/cm³.

An apparent density of the hollow silica particles can also be measured using a specific gravity bottle. A sample (hollow silica particles) and an organic solvent are put into a specific gravity bottle and left to stand at 25° C. for 48 hours, followed by measuring. Since it may take time for the organic solvent to permeate the hollow silica particles depending on denseness of the shell of the hollow silica particle, it is preferable to leave the sample and the organic solvent to stand for the above period of time. A measurement result of the method corresponds to a result of density measurement with a dry pycnometer using argon gas.

The apparent density of the hollow silica particles of the present invention can be adjusted by adjusting primary particles diameter and a shell thickness. By changing the particle density, it is possible to adjust whether the particles precipitate in the solvent, continue to be dispersed, or float on the solvent. When it is desired to disperse the particles in the solvent, a density of the solvent and the apparent density of the particles are preferably close to each other. For example, when it is desired to disperse the particles in water having a density of 1.0 g/cm³, the apparent density of the particles is preferably adjusted to 0.8 g/cm³ or more and 1.2 g/cm³ or less.

In the sample of the hollow silica particles, a proportion of complete hollow particles in which the shell layer is not broken and a space portion is held inside is referred to as a hollow particle ratio. Since the shell layer of the hollow silica particles of the present invention is dense, it is difficult for various solvents, argon gas, and gas having a dynamic molecular diameter larger than that of an argon molecule to permeate. However, when particles with broken shell layers (broken particles) are present, the various solvents, argon gas, and gas having a dynamic molecular diameter larger than that of an argon molecule penetrate into the hollow silica particles of the present invention. Thus, the apparent density varies depending on the hollow particle ratio. The higher the hollow particle ratio, the lower the apparent density of the hollow silica sample, and the lower the hollow particle ratio, the higher the apparent density of the hollow silica sample. By utilizing this, the hollow particle ratio is determined based on a theoretical density determined from the amount of raw materials charged and the apparent density measured by a dry pycnometer, assuming that a yield is 100%.

In addition, the hollow particle ratio is also determined from a weight change during heat treatment by using a filtered cake before an oil core is removed when the hollow silica particles are produced. When the filtered cake is loosened and dried overnight, an oil component in the broken particles is volatilized, and an oil component in the complete hollow particles is held. A weight change amount during heat treatment in the case where all the charged oil components are volatilized (the hollow particle ratio is 0%) and a weight change amount during heat treatment in the case where all the charged oil components are held (the hollow particle ratio is 100%) can be calculated from the amount of raw materials charged, and thus the hollow particle ratio is determined from a weight change when a sample dried overnight after filtration is subjected to a heat treatment to 800° C.

The hollow silica particles of the present invention preferably have a BET specific surface area of 1 m²/g to 100 m²/g. It is substantially difficult to set the BET specific surface area to less than 1 m²/g. When the BET specific surface area is 100 m²/g or less, it is possible to prevent an increase in the viscosity when the resin composition is prepared, and the dispersibility in the resin composition is not deteriorated. The BET specific surface area is preferably 1 m²/g to 100 m²/g, more preferably 1 m²/g to 50 m²/g, still more preferably 1 m²/g to 20 m²/g, and most preferably 1 m²/g to 15 m²/g.

The BET specific surface area is measured by a multi-point method using nitrogen gas, by a specific surface area measuring apparatus (for example, “TriStar II3020” manufactured by SHIMADZU CORPORATION), with respect to the hollow silica particles dried to 50 mTorr at 230° C. as a pre-treatment.

The hollow silica particles have a sphericity of preferably 0.75 to 1.0. When the sphericity decreases, the hollow silica particles may be easily broken, the Ar density may decrease, the specific surface area may increase, and the dielectric loss tangent may increase.

The sphericity can be represented by an average value obtained by measuring a longest diameter (DL) and a shortest diameter (DS) orthogonal to the longest diameter (DL) of any 100 particles in a photographic projection obtained by taking a photograph with a scanning electron microscope (SEM), and calculating a ratio (DS/DL) of the shortest diameter (DS) to the longest diameter (DL).

From the viewpoint of dispersibility and the like, the sphericity is more preferably 0.80 or more, still more preferably 0.82 or more, yet still more preferably 0.83 or more, particularly preferably 0.85 or more, even particularly preferably 0.87 or more, and most preferably 0.90 or more.

A size of the primary particles in the hollow silica particles is determined by directly observing a particle diameter (diameter) thereof by SEM observation. Specifically, the sizes of the primary particles in 100 particles are measured from the SEM image, and a distribution of the sizes (particle diameters) of the primary particles obtained by gathering the sizes is estimated to be a distribution of the sizes of the entire primary particles. By the SEM observation, a primary particle diameter of the particles that is difficult to deagglomerate can be directly measured.

The size of the primary particles is reflected in a particle surface state of aggregated particles, and thus serves as a parameter for determining the specific surface area and an oil absorption value.

An average value of the sizes of the primary particles (average primary particle diameter) is preferably in the range of 50 nm to 10 um. When the average primary particle diameter is less than 50 nm, the specific surface area, the oil absorption value, and a pore volume increase, a SiOH amount and adsorbed water on a particle surface increase, and the dielectric loss tangent easily increases. When the average primary particle diameter is 10 um or less, handling as a filler is easy.

From the viewpoint of production reproducibility, a lower limit of the average primary particle diameter is more preferably 70 nm or more, and most preferably 100 nm or more, and an upper limit thereof is more preferably 5 μm or less, and particularly preferably 3 μm or less.

The hollow silica particles of the present invention have the above-described average primary particle diameter, and 35% or more of all primary particles preferably have a particle diameter within the average primary particle diameter ±40%. When the particle diameter of 35% or more of the particles is within the average primary particle diameter ±1 40%, the size of the hollow silica particles becomes uniform, and thus defects of the shell of the hollow silica particles are hardly generated. It is more preferable that 40% or more of all particles have the particle diameter within the average primary particle diameter ±40%, it is still more preferable that 50% or more of all particles have the particle diameter within the average primary particle diameter ±40%, it is particularly preferable that 60% or more of all particles have the particle diameter within the average primary particle diameter ±40%, and it is most preferable that 70% or more of all particles have the particle diameter within the average primary particle diameter ±40%.

The secondary particles in the hollow silica particles preferably have a median diameter (D50) of 0.1 μm to 10 μm.

When the median diameter is 0.1 μm or more, it is possible to prevent an increase in viscosity and deterioration of dispersibility when the resin composition is prepared. The median diameter (D50) is more preferably 0.2 μm or more, still more preferably 0.25 μm or more, and particularly preferably 0.3 μm or more. In the case where the median diameter is too large, when the resin composition is formed into a film, the film becomes grainy. Therefore, the median diameter is preferably 10 μm or less, more preferably 8 μm or less, still more preferably 7 um or less, particularly preferably 5 μm or less, and most preferably 3 μm or less.

A particle diameter of the secondary particles (aggregation diameter of the primary particles during aggregation) is preferably measured by laser scattering. The reason why the aggregation diameter is measured by SEM is that a boundary between particles is unclear and the dispersion in a wet state is not reflected. In addition, in the measurement using a Coulter counter, the electric field changes differ between hollow particles and solid particles, and it is difficult to obtain corresponding numerical values as compared with the solid particles.

The secondary particles in the hollow silica particles preferably have a coarse particle diameter (D90) of 1 μm to 30 μm. In the case of producing particles having a small coarse particle diameter, it is necessary to reduce a concentration of a silica source in a reaction solution, and the productivity deteriorates. Therefore, from the viewpoint of production efficiency, the coarse particle diameter is preferably 1 μm or more. On the other hand, in the case where the coarse particle diameter is too large, when the resin composition is formed into a film, the film becomes grainy, and thus the coarse particle diameter is preferably 30 μm or less. A lower limit of the coarse particle diameter is more preferably 3 μm or more, and most preferably 5 μm or more. An upper limit thereof is preferably 30 μm or less, more preferably 25 μm or less, still more preferably 20 μm or less, and most preferably 15 μm or less.

As described above, the coarse particle diameter is also determined by measuring the particle diameter of the secondary particles by laser scattering.

A shell thickness of the hollow silica particles is preferably 0.01 to 0.3 with respect to a diameter 1 of the primary particle. When the shell thickness is less than 0.01 with respect to the diameter 1 of the primary particle, the strength of the hollow silica particles may decrease. When the ratio is lager than 0.3, the internal space portion becomes smaller, and the characteristics due to a hollow shape are not exhibited.

The shell thickness is preferably 0.02 or more, more preferably 0.03 or more, and is more preferably 0.2 or less, still more preferably 0.1 or less, with respect to the diameter 1 of the primary particle.

Here, the shell thickness is determined by measuring a shell thickness of each particle with a transmission electron microscope (TEM).

Since the hollow silica particles each have a space portion inside, a substance can be enclosed in the particle. In the hollow silica particles of the present invention, since the shell layer is dense, it is difficult for various solvents to permeate therethrough. However, when the broken particles are present, the solvents permeate into the hollow silica particles. Thus, the oil absorption value varies depending on a proportion of the broken particles.

The oil absorption value of the hollow silica particles is preferably 15 mL/100 g to 1300 mL/100 g. When the oil absorption value is 15 mL/100 g or more, the adhesion with the resin can be secured when the hollow silica particles are used in the resin composition. When the oil absorption value is 1300 mL/100 g or less, the strength of the resin can be secured when the hollow silica particles are used in the resin composition, and the viscosity of the composition can be reduced.

When the oil absorption value is large, the viscosity of the resin composition including the hollow silica particles increases. Therefore, the oil absorption value of the hollow silica particles is more preferably 1,000 mL/100 g or less, still more preferably 700 mL/100 g or less, particularly preferably 500 mL/100 g or less, and most preferably 200 mL/100 g or less. When the oil absorption value is too small, the adhesion between powder and the resin may deteriorate. Therefore, the oil absorption value is more preferably 20 mL/100 g or more.

The oil absorption value can be measures in accordance with JIS K5101-13-2:2004, and it is preferable to use boiled linseed oil.

From the relation between the proportion of the broken particles and the oil absorption value as described above, the oil absorption value can be adjusted by adjusting the proportion of the broken particles. Furthermore, since a space between the primary particles is also a space capable of holding oil, it is considered that the oil absorption value increases when the median diameter of the secondary particles in which the primary particles are aggregated is large, and the oil absorption value decreases when the median diameter of the secondary particles is small.

The hollow silica particles preferably include one or more kinds of metal M selected from the group consisting of Li, Na, K, Rb, Cs, Mg, Ca, Sr, and Ba. When the metal M is included in the hollow silica particle, the metal M acts as a flux during baking, the specific surface area decreases, and the dielectric loss tangent can be reduced.

The metal M is included between a reaction step and a washing step in the production of the hollow silica particle. For example, in the reaction step, the metal M can be included in the hollow silica particles by adding a metal salt of the metal M to a reaction solution for forming a silica shell or by washing a hollow silica precursor with a solution containing metal ions of the metal M before baking.

In the present invention, a concentration of the metal M included in the hollow silica particles is preferably 50 ppm by mass or more and 1 mass % or less. When a total concentration of the metal M is 50 ppm by mass or more, the condensation of bonded silanol groups is further promoted by a flux effect during baking and remaining silanol groups are reduced, and thus the dielectric loss tangent can be reduced. When the concentration of the metal M is too high, the amount of components that react with silica to form silicate increases and the hygroscopicity of the hollow silica particles may deteriorate, and thus the concentration of the metal M is preferably 1 mass % or less. The concentration of the metal M is preferably 100 ppm by mass or more, more preferably 150 ppm by mass or more, and is preferably 1 mass % or less, more preferably 5,000 ppm by mass or less, and most preferably 1,000 ppm by mass or less.

The metal M can be measured by ICP emission spectrometry after adding perchloric acid and hydrofluoric acid to the hollow silica particles, igniting a mixture thereof, and removing silicon which is a main component.

In the case where alkali metal silicate is used as a silica raw material, the amount of a carbon (C) component derived from the raw material in a shell layer of the obtained hollow silica particles is smaller than that in the case where silicon alkoxide is used as the silica raw material.

A kneaded product including the hollow silica particles of the present invention preferably has a viscosity of 10,000 mPa·s or less as measured by the following measurement method.

### Measuring Method

A kneaded product obtained by mixing 6 parts by mass of a boiled linseed oil and (6×A/2.2) parts by mass of the hollow silica particles where A (g/cm³) is a particle density determined by density measurement with a dry pycnometer using argon gas and kneading a resulting mixture at 2,000 rpm for 3 minutes is measured for 30 seconds at a shear rate of 1 s⁻¹using a rotary rheometer to determine a viscosity at 30 seconds.

When the viscosity at the shear rate of 1 s⁻¹ of the kneaded product determined by the above measurement method is 10,000 mPa·s or less, an amount of a solvent added at the time of forming a film of and molding the resin composition including the hollow silica particles can be reduced, a drying rate can be increased, and productivity can be improved. In addition, in the case where a product of a density according to a particle diameter of silica powder and the specific surface area is large, the viscosity tends to increase when the silica powder is added to the resin composition. However, the hollow silica particles of the present invention can prevent an increase in the viscosity of the resin composition because the product of the density and the specific surface area is small. The viscosity of the kneaded product is more preferably 8,000 mPa·s or less, still more preferably 5,000 mPa·s or less, and most preferably 4,000 mPa·s or less.

A lower limit value of the viscosity of the kneaded product at the shear rate of 1 s⁻¹ is not particularly limited because the lower the viscosity, the better coatability of the resin composition and the higher the productivity.

The silica particles are classified into four basic structures represented by Q1 to Q4 according to the connectivity of a SiO₄ tetrahedron in the assignment of a spectrum of ²⁹Si-NMR. Q1 to Q4 are as follows.

Q1 is a structural unit having one Si atom around Si via oxygen, has a SiO₄ tetrahedron connected to another SiO₄ tetrahedron, and thus has a peak in the vicinity of −80 ppm in a solid ²⁹Si-DD/MAS-NMR spectrum.

Q2 is a structural unit having two Si atoms around Si via oxygen, has a SiO₄ tetrahedron connected to the other two SiO₄ tetrahedra, and thus has a peak in the vicinity of −91 ppm in a solid ²⁹Si-DD/MAS-NMR spectrum.

Q3 is a structural unit having three Si atoms around Si via oxygen, has a SiO₄ tetrahedron connected to the other three SiO₄ tetrahedra, and thus has a peak in the vicinity of −101 ppm in a solid ²⁹Si-DD/MAS-NMR spectrum.

Q4 is a structural unit having four Si atoms around Si via oxygen, has a SiO₄ tetrahedron connected to the other four SiO₄ tetrahedra, and thus has a peak in the vicinity of −110 ppm in a solid ²⁹Si-DD/MAS-NMR spectrum.

In the hollow silica particles of the present invention, a molar ratio (Q3/Q4) of a Q3 structure having one OH group derived from a silanol group to a Q4 structure having no OH group derived from the silanol group as measured by solid ²⁹Si-DD/MAS-NMR is 2% to 40%. When Q3/Q4 is 40% or less, the amount of silanol can be reduced and the dielectric loss tangent is improved. To obtain hollow silica particles having Q3/Q4 of less than 2%, it is necessary to perform baking at a high temperature, and at this time, a hollow portion of the hollow silica shrinks, and thus it is substantially difficult to obtain hollow silica particles having Q3/Q4 of less than 2%. The Q3/Q4 is more preferably 30% or less, and still more preferably 20% or less.

The Q3/Q4 of the hollow silica particles is measured as follows.

Hollow silica particle powder is used as a measurement sample. A CP/MAS probe having a diameter of 7.5 mm is attached to a 400 MHz nuclear magnetic resonance apparatus, an observation nucleus is set to ²⁹Si, and measurement is performed by a DD/MAS method. The measurement conditions are as follows: a ²⁹Si resonance frequency of 79.43 MHz, a ²⁹Si 90° pulse width of 5 μs, a 1H resonance frequency of 399.84 MHz, a 1H decoupling frequency of 50 kHz, a MAS rotation speed of 4 kHz, a spectrum width of 30.49 kHz, and a measurement temperature of 23° C. In the data analysis, for each peak of a spectrum after Fourier transform, optimization calculation is performed by a nonlinear least squares method using a center position, a height, and a half width of a peak shape created by mixing a Lorentz waveform and a Gaussian waveform as variable parameters. For the four structural units Q1, Q2, Q3, and Q4, the molar ratio of Q3 and Q4 is calculated from the determined content of Q1, content of Q2, content of Q3, and content of Q4.

In the present embodiment, a content of the silanol groups in the silica particles is measured not by a Cross Polarization/Magic Angle Spinning method (CP/MAS) but by a Dipolar Decoupling/Magic Angle Spinning method (DD/MAS).

In the CP/MAS method, since ¹H sensitizes and detects Si existing in the vicinity thereof, the obtained peak does not accurately reflect the content of Q1, the content of Q2, the content of Q3, and the content of Q4.

On the other hand, since the DD/MAS method has no sensitizing effect like the CP/MAS method, the obtained peak accurately reflects the content of Q1, the content of Q2, the content of Q3, and the content of Q4, and is suitable for quantitative analysis.

A pore volume of the hollow silica particles is preferably 0.2 cm³/g or less.

When the pore volume is larger than 0.2 cm³/g, moisture is easily adsorbed, and the dielectric loss of the resin composition may deteriorate. The pore volume is more preferably 0.15 cm³/g or less, still more preferably 0.1 cm³/g or less, and particularly preferably 0.05 cm³/g or less.

The pore volume is determined by a BJH method based on a nitrogen adsorption method using a specific surface area and pore distribution measurement device (for example, “BELSORP-mini II” manufactured by MicrotracBEL Corp., “TriStar II” manufactured by Micromcritics Instrument Corporation).

A surface of the hollow silica particles is preferably treated with a silane coupling agent.

When the surface of the hollow silica particles is treated with the silane coupling agent, an amount of silanol groups remaining on the surface is reduced, the surface is hydrophobized, and the dielectric loss can be improved by preventing water adsorption. Further, when the resin composition is prepared, affinity with the resin is improved, and dispersibility and strength after resin film formation are improved.

Examples of the silane coupling agent include aminosilane coupling agents, epoxysilane coupling agents, mercaptosilane coupling agents, silane-based coupling agents, and organosilazane compounds. The silane coupling agent may be used alone or in combination of two or more kinds thereof.

An adhesion amount of the silane coupling agent is preferably 1 part by mass or more, more preferably 1.5 parts by mass or more, and still more preferably 2 parts by mass or more, and is preferably 10 parts by mass or less, more preferably 8 parts by mass or less, and still more preferably 5 parts by mass or less, with respect to 100 parts by mass of the hollow silica particles. That is, the adhesion amount of the silane coupling agent is preferably in the range of 1 to 10 parts by mass with respect to 100 parts by mass of the hollow silica particles.

The fact that the surface of the hollow silica particles is treated with the silane coupling agent can be confirmed by detecting a peak due to a substituent group of the silane coupling agent using IR. The adhesion amount of the silane coupling agent can be measured by an amount of carbon.

The hollow silica particles of the present invention preferably have a relative permittivity at 1 GHz of 1.3 to 5.0. In particular, in the measurement of a permittivity of the powder, a sample space becomes small and a measurement accuracy deteriorates at 10 GHz or more, and thus a measurement value at 1 GHz is adopted in the present invention. When the relative permittivity at 1 GHz is within the above range, a low relative permittivity required for an electronic device can be achieved. It is substantially difficult to synthesize the hollow silica particles having a relative permittivity at 1 GHz of less than 1.3.

A lower limit of the relative permittivity at 1 GHz is preferably 1.3 or more, and more preferably 1.4 or more. An upper limit thereof is more preferably 4.5 or less, still more preferably 4.0 or less, particularly preferably 3.5 or less, further particularly preferably 3.0 or less, and most preferably 2.5 or less.

The hollow silica particles of the present invention preferably have dielectric loss tangent at 1 GHz. of 0.0001 to 0.05. When the dielectric loss tangent at 1 GHz is 0.05 or less, a low relative permittivity required for an electronic device can be achieved. In addition, it is substantially difficult to synthesize the hollow silica particles having dielectric loss tangent at 1 GHz of less than 0.0001.

A lower limit of the dielectric loss tangent at 1 GHz is more preferably 0.0002 or more, and still more preferably 0.0003 or more. An upper limit thereof is more preferably 0.01 or less, still more preferably 0.005 or less, even still more preferably 0.003 or less, particularly preferably 0.002 or less, further particularly preferably 0.0015 or less, and most preferably 0.0010 or less.

The relative permittivity and the dielectric loss tangent can be measured by a perturbation resonator method using a dedicated device (for example, “vector network analyzer E5063A” manufactured by a KEYCOM Corp.).

### Resin Composition and Slurry Composition

The hollow silica particles of the present invention can be mixed with a resin and used as a resin composition.

The resin composition according to the present embodiment includes the hollow silica particles of the present invention and the resin. A content of the hollow silica particles in the resin composition is preferably 5 mass % to 70 mass %, and more preferably 10 mass % to 50 mass %.

The resin may use one or two or more types selected from the group consisting of: a polyester such as polybutylene terephthalate, polyethylene terephthalate, an unsaturated polyester, or an aromatic polyester; a fluororesin such as polytetrafluoroethylene (PTFE), a tetrafluoroethylene-perfluoroalkyl vinylether copolymer (PFA), a tetrafluoroethylene-hexafluoropropylene copolymer (FEP), or a tetrafluoroethylene-ethylene copolymer (ETFE); an epoxy resin; a silicone resin; a phenol resin; a melamine resin; a urea resin; polyimide; polyamide imide; polyether imide; polyamide; polyphenylene ether; polyphenylene sulfide; polysulfone; a liquid crystal polymer; polyethersulfone; polycarbonate; a maleimide modified resin; an acrylonitrile-butadiene-styrene (ABS) resin; an acrylonitrile-acrylic rubber-styrene (AAS) resin; and an acrylonitrile-ethylene-propylene-diene rubber-styrene (AES) resin. Since the dielectric loss tangent in the resin composition also depends on characteristics of the resin, the resin to be used may be selected in consideration of this factor.

The hollow silica particles of the present invention can be used as a filler of a slurry composition. The slurry composition refers to a muddy composition in which the hollow silica particles of the present invention are dispersed in an aqueous or oily medium.

A content of the hollow silica particles in the slurry composition is preferably 1 mass % to 40 mass %, and more preferably 5 mass % to 40 mass %.

Examples of the oily medium include acetone, methanol, ethanol, butanol, 2-propanol, 2-methoxyethanol, 2-ethoxyethanol, 1-methoxy-2-propanol, 2-acetoxy-1-methoxypropane, toluene, xylene, methyl ethyl ketone, N,N-dimethylformamide, methyl isobutyl ketone, N-methylpyrrolidone, n-hexane, cyclohexane, cyclohexanone, and naphtha as a mixture. The above may be used alone or as a mixture of two or more kinds thereof.

The resin composition and the slurry composition may include an optional component other than the resin and the medium. Examples of the optional component include a dispersion aid, a surfactant, and a filler other than silica.

When a resin film is produced using the resin composition including the hollow silica particles of the present invention, a relative permittivity thereof at the frequency of 10 GHz is preferably 2.0 to 3.5. A lower limit of the relative permittivity at the frequency of 10 GHz is more preferably 2.2 or more, and still more preferably 2.3 or more, and an upper limit thereof is more preferably 3.2 or less, and still more preferably 3.0 or less. In the case where the relative permittivity of the resin film at the frequency of 10 GHz is within the above range, the resin film can be expected to be used for electronic devices, communication devices, and the like because of excellent electrical characteristics.

The dielectric loss tangent of the resin film at the frequency of 10 GHz is preferably 0.01 or less, more preferably 0.008 or less, and still more preferably 0.0065 or less. In the case where the dielectric loss tangent of the resin film at the frequency of 10 GHz is within the above range, the resin film can be expected to be used for electronic devices, communication devices, and the like because of excellent electrical characteristics. As the dielectric loss tangent is smaller, a transmission loss of a circuit is reduced, and thus, a lower limit value thereof is not particularly limited.

The relative permittivity and the dielectric loss tangent of the resin film can be measured using a split post dielectric resonator (SPDR) (for example, manufactured by Agilent Technologies Japan, Ltd.).

The resin film preferably has an average coefficient of linear expansion of 10 ppm/° C. to 50 ppm/° C. When the average coefficient of linear expansion is in the above range, the range is close to a coefficient of thermal expansion of a copper foil widely used as a base material, and thus, the electrical characteristics are excellent. The average coefficient of linear expansion is more preferably 12 ppm/° C.; or more, still more preferably 15 ppm/° C. or more, and more preferably 40 ppm/° C. or less, and still more preferably 30 ppm/° C. or less.

The average coefficient of linear expansion is determined by heating the resin film at a load of 5 N and a temperature increase rate of 2° C./min, measuring a dimensional change of a sample from 30° C. to 150° C., and calculating an average with using a thermomechanical analyzer (for example, “TMA-60” manufactured by SHIMADZU CORPORATION).

The resin film preferably has a peel strength of 30 N/mm or more when laminated with a metal. When the peel strength is in the above range, peeling of the metal and the resin composition can be prevented after the downstream process after lamination. The peel strength is preferably 30 N/mm or more, more preferably 40 N/mm or more, and most preferably 50 N/mm or more.

The peel strength can be measured using a 90° peel tester or the like after the resin composition is laminated with the metal.

### Method for Producing Hollow Silica Particles

Examples of the method for producing hollow silica particles of the present invention include a method in which an oil-in-water emulsion including an aqueous phase, an oil phase, and a surfactant is used, a hollow silica precursor is obtained in the emulsion, and hollow silica particles are obtained from the precursor. The oil-in-water emulsion is an emulsion having an oil phase dispersed in water, and when a silica raw material is added to the emulsion, the silica raw material is adhered to oil droplets, whereby oil core-silica shell particles can be formed.

The method for producing the hollow silica particles of the present invention includes: preparing an oil-in-water emulsion including an aqueous phase, an oil phase, and a surfactant; leaving the oil-in-water emulsion at rest for 0.5 hours to 240 hours to obtain a hollow silica precursor in which a shell layer including silica is formed on an outer periphery of a core in the oil-in-water emulsion; and removing the core from the hollow silica precursor, followed by performing a heat treatment. When the hollow silica precursor is obtained, it is preferred that a first silica raw material is added to the oil-in-water emulsion to form a first-stage shell, and a second silica raw material is added to the emulsion in which the first-stage shell is formed to form a second-stage shell, thereby forming a shell layer on the outer periphery of the core.

Hereinafter, the oil-in-water emulsion is also simply referred to as an emulsion. Further, a dispersion having oil core-silica shell particles dispersed, formed by adding the first silica raw material and not having the second silica raw material added yet, and a dispersion having oil core-silica shell particles dispersed, having the second silica raw material added, may also be sometimes referred to as an emulsion. The latter dispersion having oil core-silica shell particles dispersed, having the second silica raw material added may be the same as a hollow silica precursor dispersion.

### <First-Stage Shell Formation>

First, the first silica raw material is added to an oil-in-water emulsion including an aqueous phase, an oil phase, and a surfactant to form a first-stage shell.

The aqueous phase of the emulsion mainly includes water as a solvent. The aqueous phase may further include a water-soluble organic liquid or an additive such as a water-soluble resin. A proportion of the water in the aqueous phase is preferably 50 mass % to 100 mass %, more preferably 90 mass % to 100 mass %.

The oil phase of the emulsion preferably includes a water-insoluble organic liquid which is incompatible with an aqueous phase component. The organic liquid forms droplets in the emulsion to thereby form an oil core portion of the hollow silica precursor.

Examples of the organic liquid include an aliphatic hydrocarbon such as n-hexane, isohexane, n-heptane, isoheptane, n-octane, isooctane, n-nonane, isononane, n-pentane, isopentane, n-decane, isodecane, n-dodecane, isododecane or pentadecane, a paraffin base oil which is a mixture thereof, an alicyclic hydrocarbon such as cyclopentane, cyclohexane or cyclohexene, a naphthene base oil which is a mixture thereof, an aromatic hydrocarbon such as benzene, toluene, xylene, ethylbenzene, propylbenzene, cumene, mesitylene, tetralin or styrene, an ether such as propyl ether or isopropyl ether, an ester such as ethyl acetate, n-propyl acetate, isopropyl acetate, n-butyl acetate, isobutyl acetate, n-amyl acetate, isoamyl acetate, butyl lactate, methyl propionate, ethyl propionate, butyl propionate, methyl butyrate, ethyl butyrate or butyl butyrate, a vegetable oil such as palm oil, soybean oil or rapeseed oil, or a fluorinated solvent such as a hydrofluorocarbon, a perfluorocarbon or a perfluoropolyether. Further, a polyoxyalkylene glycol to be a hydrophobic liquid at a shell forming reaction temperature may also be used. Examples thereof include polypropylene glycol (molecular weight of 1,000 or more), or a polyoxyethylene-polyoxypropylene block copolymer having a proportion of oxyethylene units of less than 20 mass % and a cloudy point (1 mass % aqueous solution) of 40° C. or lower, preferably 20° C. or lower. Among them, a polyoxypropylene-polyoxyethylene-polyoxypropylene type block copolymer is preferably used.

These may be used alone or in combination of two or more so long as a single oil phase is formed.

The organic liquid is preferably a hydrocarbon having 8 to 16 carbon atoms, particularly 9 to 12 carbon atoms. The organic liquid is selected comprehensively considering the workability, the safety against fire, separation property of the hollow silica precursor and the organic liquid, shape characteristics of the hollow silica particles, solubility of the organic liquid in water, and the like. The hydrocarbon having 8 to 16 carbon atoms may be any of linear, branched and cyclic hydrocarbons so long as the hydrocarbon is chemically stable, or may be a mixture of hydrocarbons differing in the number of carbon atoms. The hydrocarbon is preferably a saturated hydrocarbon, and more preferably a linear saturated hydrocarbon.

The organic liquid preferably has a flash point of 20° C. or more, and more preferably 40° C. or more. In the case where an organic liquid having a flash point of less than 20° C. is used, countermeasures in the work environment are required for fire control due to too low flash point.

The emulsion includes a surfactant so as to improve emulsification stability. The surfactant is preferably water-soluble or water-dispersible, and is used preferably as added to the aqueous phase. The surfactant is preferably a nonionic surfactant.

Examples of the nonionic surfactant include the following surfactants:
Polyoxyethylene-Polyoxypropylene Copolymer Type Surfactants;
Polyoxyethylene sorbitan fatty acid ester type surfactants: polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate;
Polyoxyethylene higher alcohol ether type surfactants: polyoxyethylene lauryl ether, polyoxyethylene cetyl ether, polyoxyethylene stearyl ether, polyoxyethylene oleyl ether, polyoxyethylene octyl phenol ether, polyoxyethylene nonyl phenol ether;
Polyoxyethylene aliphatic ester type surfactants: polyoxyethylene glycol monolaurate, polyoxyethylene glycol monostearate, polyoxyethylene glycol monooleate;
Glycerin fatty acid ester type surfactants: stearic acid monoglyceride, oleic acid monoglyceride.

Further, a polyoxyethylene sorbitol fatty acid ester type surfactant, a sucrose fatty acid ester type surfactant, a polyglycerin fatty acid ester type surfactant, a polyoxyethylene hydrogenated caster oil type surfactant or the like may also be used.

These may be used alone or in combination of two or more kinds thereof.

Among the nonionic surfactants described above, the polyoxyethylene sorbitan fatty acid ester type surfactants and the polyoxyethylene-polyoxypropylene copolymer type surfactants are preferably used. The polyoxyethylene-polyoxypropylene copolymer is a block copolymer having a polyoxyethylene block (EO) and a polyoxypropylene block (PO) bonded. Examples of the block copolymer include an EO-PO-EO block copolymer or an EO-PO block copolymer, and the block copolymer is preferably an EO-PO-EO block copolymer. A proportion of oxyethylene units in the EO-PO-EO block copolymer is preferably 20 mass % or more, and more preferably 30 mass % or more.

A weight average molecular weight of the polyoxyethylene-polyoxypropylene copolymer is preferably 3,000 to 27,000, and more preferably 6,000 to 19,000.

To the entire polyoxyethylene-polyoxypropylene copolymer, a total amount of the polyoxyethylene block is preferably 40 mass % to 90 mass %, and a total amount of the polyoxypropylene block is preferably 10 mass % to 60 mass %.

The amount of the surfactant used varies depending upon the conditions such as the type of the surfactant, the hydrophile-lipophile balance (HLB) which is an index indicating the degree of hydrophilicity or hydrophobicity of the surfactant, and the particle diameter of the silica particles desired, and a content of the surfactant in the aqueous phase is preferably 500 ppm by mass to 20,000 ppm by mass, and more preferably 1,000 ppm by mass to 10,000 ppm by mass. When the content of the surfactant is 500 ppm by mass or more, the emulsion can be more stabilized. Further, when the content of the surfactant is 20,000 ppm by mass or less, the amount of the surfactant remaining in the hollow silica particles can be reduced.

The aqueous phase and the oil phase may be blended in a mass ratio of 200:1 to 5:1, preferably 100:1 to 9:1.

The method of preparing the oil-in-water emulsion is not limited to the following description. The aqueous phase and the oil phase are preliminarily prepared, and the oil phase is added to the aqueous phase, followed by sufficient mixing or stirring, whereby the oil-in-water emulsion can be prepared. Further, ultrasonic emulsification of physically applying a strong shearing force, emulsification by stirring, high pressure emulsification or the like may be employed. Further, membrane emulsification method of having the fine oil phase obtained by passing through a membrane having fine pores dispersed in the aqueous phase, phase inversion emulsification method of dissolving the surfactant in the oil phase and then adding the aqueous phase and conducting emulsification, or a phase inversion temperature emulsification method of utilizing a phenomenon that the surfactant changes from water-soluble to oil-soluble at a temperature around the cloudy point may, for example, be mentioned. The emulsification methods may be properly selected depending upon the desired particle diameter, particle diameter distribution, and the like.

In order to decrease the particle diameter of the hollow silica particles to be obtained and to narrow the particle diameter distribution, it is preferred that the oil phase is sufficiently dispersed in the aqueous phase and the mixed liquid is emulsified. For example, the mixed liquid may be emulsified by a high pressure homogenizer under a pressure of 10 bar or more, preferably 20 bar or more.

In the present invention, a step of aging the obtained oil-in-water emulsion is provided. By performing the aging step, the fine emulsion preferentially grows, a primary particle diameter of the hollow silica to be obtained becomes uniform, and the distribution of the primary particle diameter becomes narrow. Accordingly, the product (A×B) of the Ar density and the BET specific surface area can be reduced. An aging time is 0.5 hours to 240 hours. When the aging time is 0.5 hours or more, the uniformity of the particle diameter of the primary particles is increased, and when the aging time is 240 hours or less, the productivity is good. The aging time is preferably 0.5 hours to 96 hours, and most preferably 0.5 hours to 48 hours.

An aging temperature is preferably 5° C. to 80° C., more preferably 20° C. to 70° C., and most preferably 20° C. to 55° C.

In the first-stage shell formation step, the first silica raw material is added to the oil-in-water emulsion.

Examples of the first silica raw material include an aqueous solution having water-soluble silica dissolved, an aqueous dispersion having solid silica dispersed, a mixture thereof, or at least one member selected from the group consisting of an alkali metal silicate, activated silicic acid and a silicon alkoxide, or an aqueous solution or aqueous dispersion thereof. Among them, at least one member selected from the group consisting of an alkali metal silicate, activated silicic acid and a silicon alkoxide, or an aqueous solution or aqueous dispersion thereof, is preferable in view of availability.

Examples of the solid silica include silica sol obtained by hydrolyzing an organic silicon compound, or commercially available silica sol.

Examples of the alkali metal of the alkali metal silicate include lithium, sodium, potassium or rubidium, and among them, in view of availability and the cost, sodium is preferable. That is, alkali metal silicate is preferably sodium silicate. Sodium silicate has a composition represented by Na₂O·nSiO₂·mH₂O. A proportion of sodium to silicate is, by the molar ration of Na₂O/SiO₂, preferably 1.0 to 4.0, further preferably 2.0 to 3.5.

The activated silicic acid is one obtained by subjecting an alkali metal silicate to cation exchange treatment to replace the alkali metal with hydrogen, and the aqueous solution of the activated silicic acid is weakly acidic. For the cation exchange, a hydrogen form cation exchange resin may be used.

The alkali metal silicate or the activated silicic acid is preferably added to the emulsion after dissolving or dispersing in water. A concentration of the alkali metal silicate or activated silicic acid aqueous solution is, as a SiO₂ concentration, preferably 3 mass % to 30 mass %, more preferably 5 mass % to 25 mass %.

As the silicon alkoxide, for example, a tetraalkoxysilane such as tetramethoxysilane, tetraethoxysilane or tetrapropoxysilane is preferably used.

Further, by mixing other metal oxide or the like with the silica raw material, composite particles may be obtained. Examples of such other metal oxide include titanium dioxide, zinc oxide, cerium oxide, copper oxide, iron oxide or tin oxide.

As the first silica raw material, the above-described silica raw material can be used alone or in combination of two or more kinds thereof. Among them, as the first silica raw material, an alkali metal silicate aqueous solution, particularly a sodium silicate aqueous solution is preferably used.

The first silica raw material is preferably added to the oil-in-water emulsion under an acidic condition. By adding the silica raw material under an acidic environment, silica fine particles are generated to form a network, thereby forming a first-stage coating film. To maintain the stability of the emulsion, a reaction temperature is preferably 80° C. or lower, more preferably 70° C. or lower, still more preferably 60° C. or lower, particularly preferably 50° C.′ or lower, and most preferably 40° C.′ or lower. From the viewpoint of controlling a network formation rate of the silica fine particles to make a thickness of the coating film uniform, the reaction temperature is preferably 4° C. or more, more preferably 10° C. or more, still more preferably 15° C. or more, particularly preferably 20° C. or more, and most preferably 25° C. or more. That is, the reaction temperature is preferably in the range of 4° C. to 80° C.

A pH of the oil-in-water emulsion is more preferably less than 3, still more preferably 2.5 or less, and even still more preferably 1 or more, from the viewpoint of making the thickness of the coating film more uniform and making a silica shell layer of the hollow silica to be obtained denser. That is, the pH of the oil-in-water emulsion is preferably in the range of 1 or more and less than 3.

In order to make the pH of the oil-in-water emulsion acidic, an acid may be added.

Examples of the acid include hydrochloric acid, nitric acid, sulfuric acid, acetic acid, perchloric acid, hydrobromic acid, trichloroacetic acid, dichloroacetic acid, methanesulfonic acid or benzenesulfonic acid.

At the time of adding the first silica raw material, as the amount of the first silica raw material added, the amount of SiO₂ in the first silica raw material is preferably 1 parts by mass to 50 parts by mass, more preferably 3 parts by mass to 30 parts by mass with respect to 100 parts by mass of the oil phase included in the emulsion.

At the time of adding the first silica raw material, after adding the first silica raw material, the pH of the emulsion is maintained to be acidic for preferably 1 minute or more, more preferably 5 minutes or more, and still more preferably 10 minutes or more.

Next, the pH of the emulsion having the first silica raw material added is preferably maintained at 3 or more and 7 or less (from weakly acidic to neutral). Accordingly, the first silica raw material can be fixed to the surface of the oil droplets.

For example, the pH of the emulsion may be kept to be 3 or more by adding a base to the emulsion having the first silica raw material added.

Examples of the base include an alkali metal hydroxide such as sodium hydroxide or potassium hydroxide, an alkaline earth metal hydroxide such as magnesium hydroxide or calcium hydroxide, ammonia or an amine.

Alternatively, a method of replacing an anion such as a halogen ion with a hydroxide ion by anion exchange treatment may be employed.

At the time of adding the base, it is preferable to gradually add the base while the emulsion having the first silica raw material added is stirred so as to gradually increase the pH of the emulsion. In the case where stirring is not intense, or a large amount of the base is added all at once, the pH of the emulsion tends to be non-uniform, and the thickness of a first layer coating film may be non-uniform.

The emulsion is preferably maintained with stirring. A retention time is preferably 10 minutes or more, more preferably 1 hour or more, and may be 4 hours or more. To maintain the stability of the emulsion, a retention temperature is preferably 100° C. or lower, more preferably 95° C. or lower, still more preferably 90° C. or lower, and particularly preferably 85° C. or lower. To promote aging, the retention temperature is preferably 35° C. or higher, more preferably 40° C. or higher, and particularly preferably 45° C. or higher. That is, the retention temperature of the emulsion is preferably in the range of 35° C. to 100° C.

### <Second-Stage Shell Formation>

Next, the second silica raw material is added to the emulsion in the presence of alkali metal ions. Accordingly, the hollow silica precursor dispersion is obtained. The hollow silica precursor is in the form of oil core-silica shell particles.

The second silica raw material is preferably added to the emulsion under an alkaline condition.

At the time of adding the first silica raw material, in order to make the adhesion of the first silica raw material to the oil droplets more uniform, the method of once acidifying the emulsion and then adjusting the pH to be 3 to 7 (weakly acidic to neutral) is employed. A first silica layer obtained by such a method is porous and has insufficient denseness and thus has low strength. By alkalifying the emulsion at the time of adding the second silica raw material, a high-density second silica layer can be formed on the obtained first silica layer.

To prevent generation of new fine particles, the pH of the emulsion when the second silica raw material is added is preferably 8 or more, more preferably 8.5 or more, still more preferably 8.7 or more, particularly preferably 8.9 or more, and most preferably 9 or more. When the pH is too high, the solubility of silica increases. Therefore, the pH is preferably 13 or less, more preferably 12.5 or less, still more preferably 12 or less, particularly preferably 11.5 or less, and most preferably 11 or less. That is, the pH of the emulsion is preferably in the range of 8 to 13.

In order to make the pH of the oil-in-water emulsion alkaline, a base may be added. As the base, the same compounds as those described above are used.

As the second silica raw material, a material similar to the first silica raw material may be used alone or in combination of two or more kinds thereof. Among them, at the time of adding the second silica raw material, at least one of the sodium silicate aqueous solution and the activated silicic acid aqueous solution is preferably used.

When the second silica raw material is added to the emulsion under the alkaline condition, a method of adding an alkali metal hydroxide simultaneously with addition of the second silica raw material may be employed. In addition, a method of using sodium silicate as the alkali metal silicate for the second silica raw material may also be employed. In such a case, the sodium silicate as an alkali component is added to the weakly acidic emulsion having the pH adjusted to be 5 or more after adding the first silica raw material, and accordingly the pH of the emulsion can be maintained to be alkaline while the second silica raw material is added. Further, the alkali metal ions is present in the emulsion.

In a case where the pH is too high, for example, in a case where the sodium silicate aqueous solution is used as the second silica raw material, an acid may be added to adjust the pH. The acid to be used may be the same acid as that used when the first silica raw material is added.

The second silica raw material is preferably added in the presence of alkali metal ions. The alkali metal ions may be derived from the first silica raw material, may be derived from the second silica raw material, or may be derived from the base added to adjust the pH, or may be incorporated, for example, by addition of an additive to the emulsion. For example, an alkali metal silicate is used as at least one of the first silica raw material and the second silica raw material. In addition, as the additive to the emulsion, a halide, sulfate, nitrate, fatty acid salt or the like of an alkali metal is used.

In the case where the second silica raw material is added, for example, at least one of the sodium silicate aqueous solution and the activated silicic acid aqueous solution may be added to the emulsion after adding the first silica raw material, or both may be added. In a case where both are added, the sodium silicate aqueous solution and the activated silicic acid aqueous solution may be added all at once, or may be added in order.

Addition of the second silica raw material may be carried out, for example, by conducting a step of adding the sodium silicate aqueous solution and a step of adding the activated silicic acid aqueous solution once or repeatedly two or more times, so as to promote adhesion of the silica raw material to the first silica layer while the pH is adjusted.

The second silica raw material is preferably added to the emulsion heated so as to promote adhesion of the silica raw material to the first silica layer. To prevent generation of new fine particles, the temperature of the emulsion is preferably 30° C. or higher, more preferably 35° C. or higher, still more preferably 40°° C. or higher, particularly preferably 45° C. or higher, and most preferably 50° C. or higher. When the temperature is too high, the solubility of silica increases. Therefore, the temperature is preferably 100° C. or lower, more preferably 95° C. or lower, still more preferably 90° C. or lower, particularly preferably 85° C. or lower, and most preferably 80° C. or lower. That is, the temperature of the emulsion when the second silica raw material is added is preferably in the range of 30° C. to 100° C. In the case where the heated emulsion is used, after adding the second silica raw material, the formed emulsion is preferably gradually cooled to room temperature (about 23° C.).

At the time of adding the second silica raw material, the amount of the second silica raw material added is preferably adjusted so that the amount of SiO₂ in the second silica raw material is 20 parts by mass to 500 parts by mass, more preferably 40 parts by mass to 300 parts by mass with respect to 100 parts by mass of the oil phase.

At the time of adding the second silica raw material, the pH of the emulsion is preferably maintained to be alkaline after adding the second silica raw material for 10 minutes or more.

By the addition of the first silica raw material and the addition of the second silica raw material, a total added amount of the first silica raw material and the second silica raw material is preferably adjusted so that a total amount of SiO₂ in the first silica raw material and SiO₂ in the second silica raw material is 30 parts by mass to 500 parts by mass, more preferably 50 parts by mass to 300 parts by mass with respect to 100 parts by mass of the oil phase.

The silica shell layer of the present invention may be constituted mainly by silica, and if necessary, other metal component such as Ti or Zr may be incorporated, for example, for the refractive index adjustment. The method of incorporating other metal component is not particularly limited, and for example, in the step of adding the silica raw material, the method of simultaneously adding a metal sol solution or a metal salt aqueous solution may be adopted.

The hollow silica precursor dispersion is obtained as described above.

Examples of the method of obtaining the hollow silica precursor from the hollow silica precursor dispersion include a method of subjecting the dispersion to filtration, a method of removing the aqueous phase by heating, or a method of separating the precursor by sedimentation separation or centrifugal separation.

As an example, a method of subjecting the dispersion to filtration through a filter of about 0.1 μm to about 5 μm, and drying the filtered hollow silica precursor may be mentioned.

Further, if necessary, the obtained hollow silica precursor may be washed with water, an acid, an alkali, an organic solvent or the like.

### <Heat Treatment of Hollow Silica Precursor>

The oil core is removed from the hollow silica precursor and subjected to a heat treatment. Examples of the method of removing the oil core include a method of baking the hollow silica precursor so that the oil is burnt and decomposed, a method of volatilizing the oil by drying, a method of adding an appropriate additive to decompose the oil, or a method of extracting the oil, for example, with an organic solvent. Among them, a method of baking the hollow silica precursor with low residual of oil so that the oil is burnt and decomposed is preferable.

Hereinafter, a method of baking the hollow silica precursor to remove the oil core, followed by performing a heat treatment will be described as an example.

In the method of obtaining the hollow silica particles by removing the oil core by baking the hollow silica precursor, the heat treatment is preferably performed at different temperatures in at least two stages. The oil core is removed by a first-stage heat treatment, and the shell layer of the hollow silica particles is densified by a second-stage heat treatment.

In the first-stage heat treatment, organic components of the oil core and the surfactant are removed. Since it is necessary to thermally decompose the oil in the hollow silica precursor, the first-stage heat treatment is performed at a temperature of preferably 100° C. or higher, more preferably 200° C. or higher, and most preferably 300° C. or higher. When the first-stage heat treatment is performed at an excessively high temperature, the densification of the silica shell proceeds and it is difficult to remove an organic component inside the silica shell, and therefore, the first-stage heat treatment is performed at a temperature of preferably lower than 700° C., preferably 550° C. or lower, more preferably 530° C. or lower, still more preferably 520° C. or lower, particularly preferably 510° C. or lower, and most preferably 500° C. or lower. That is, a first-stage heat treatment temperature is preferably in the range of 100° C. or higher and lower than 700° C. The first-stage heat treatment may be performed once or may be performed a plurality of times.

A first-stage heat treatment time is preferably 30 minutes or more, preferably 1 hour or more, and more preferably 2 hours or more, and is preferably 48 hours or less, more preferably 24 hours or less, and more preferably 12 hours or less. That is, the first-stage heat treatment time is preferably in the range of 30 minutes or more and 48 hours or less.

In a second-stage heat treatment, the hollow silica particles are baked to densify the shell, and the amount of the silanol groups on the surface is reduced to cause the dielectric loss tangent to decrease. A second-stage baking temperature is preferably higher than the first-stage heat treatment temperature.

When the second-stage heat treatment is performed by leaving to stand, the second-stage heat treatment is preferably performed at 700° C. or higher, more preferably 800° C. or higher, still more preferably 900° C. or higher, and most preferably 1,000° C. or higher. When the temperature is too high, the amorphous silica is crystallized to increase the relative permittivity. Therefore, the temperature is preferably 1,200° C. or lower, more preferably 1,150° C. or lower, and most preferably 1,100° C. or lower. That is, in the case where a second-stage heat treatment is performed by leaving to stand, the heat treatment temperature is preferably in the range of 700° C. to 1200° C.

In the case where the second-stage heat treatment is performed by leaving to stand, the second-stage heat treatment temperature is preferably higher than the first-stage heat treatment temperature by 200° C. or higher, more preferably 200° C. to 800° C., and still more preferably 400° C. to 700° C. The second-stage heat treatment may be performed once or may be performed a plurality of times.

In the case where the second-stage heat treatment is performed by leaving to stand, a second-stage heat treatment time is preferably 10 minutes or more, more preferably 30 minutes or more, and is preferably 24 hours or less, more preferably 12 hours or less, and most preferably 6 hours or less. That is, the second-stage heat treatment time is preferably in the range of 10 minutes or more and 24 hours or less.

The second-stage heat treatment may use a spray combustion method. A flame temperature at that time is preferably 1,000° C. or higher, more preferably 1,200° C. or higher, and most preferably 1,400° C. or higher. Further, the flame temperature is preferably 2,000° C. or lower, more preferably 1,800° C. or lower, and most preferably 1,600° C. or lower. That is, the second-stage heat treatment temperature in the spray combustion method is preferably in the range of 1,000° C. to 2,000° C.

The temperature of he hollow silica precursor may be returned to room temperature after the first-stage baking and before the second-stage heat treatment, or may be increased to the second-stage heat treatment temperature from a state in which the first-stage baking temperature is maintained.

### <Surface Treatment of Hollow Silica Baked Particle>

Thereafter, the hollow silica baked particles after the heat treatment obtained in the above step may be surface-treated with a silane coupling agent. In the step, a silanol group present on a surface of the hollow silica baked particles reacts with the silane coupling agent, and thus the amount of silanol groups on the surface can be decreased, and the dielectric loss tangent can be reduced. Since the surface is hydrophobized and the affinity for the resin is improved, the dispersibility in the resin is improved.

The conditions for the surface treatment are not particularly limited, and general surface treatment conditions may be used, and a wet treatment method or a dry treatment method may be used. From the viewpoint of performing a uniform treatment, a wet treatment method is preferable.

Examples of the silane coupling agent used in the surface treatment include aminosilane coupling agents, epoxysilane coupling agents, mercaptosilane coupling agents, silane-based coupling agents, and organosilazane compounds. These may be used alone or in combination of two or more kinds thereof.

Specifically, examples of a surface treatment agent include an aminosilane coupling agent such as aminopropylmethoxysilane, aminopropyltriethoxysilane, ureidopropyltriethoxysilane, N-phenylaminopropyltrimethoxysilane, and N-2(aminoethyl)aminopropyltrimethoxysilane, an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane, a mercaptosilane coupling agent such as mercaptopropyltrimethoxysilane and mercaptopropyltriethoxysilane, a silane-based coupling agent such as methyltrimethoxysilane, vinyltrimethoxysilane, octadecyltrimethoxysilane, phenyltrimethoxysilane, methacroxypropyltrimethoxysilane, imidazolesilane, triazinesilane, a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, C₈F₁₇-O—CF(CF₃)CF₂-O—C₃H₆SiCl₃, C₃F₇-O—(CF(CF₃)CF₂-O)₂-CF(CF₃)CONH—(CH₂)₃Si(OCH₃)₃, and an organosilazane compounds such as hexamethyldisilazane, hexaphenyldisilazane, trisilazane, cyclotrisilazane, and 1,1,3,3,5,5-hexamethylcyclotrisilazane.

A treatment amount of the silane coupling agent is preferably 1 part by mass or more, more preferably 1.5 parts by mass or more, and still more preferably 2 parts by mass or more, and is preferably 10 parts by mass or less, more preferably 8 parts by mass or less, and still more preferably 5 parts by mass or less, with respect to 100 parts by mass of the hollow silica particles. That is, the treatment amount of the silane coupling agent is preferably in the range of 1 part by mass to 10 parts by mass with respect to 100 parts by mass of the hollow silica particles.

Examples of the method for treating with the silane coupling agent include a dry method in which the silane coupling agent is sprayed to the hollow silica baked particles, and a wet method in which the hollow silica baked particles are dispersed in a solvent and then a silane coupling agent is added to react with the particles.

The hollow silica particles obtained in the above step may be aggregated by the drying or baking step, and thus may be disintegrated into a handleable aggregation diameter. Examples of the disintegration method include a method using a mortar, a method using a dry or wet ball mill, a method of using a sieve shaker, or a method of using a disintegrator such as a pin mill, a cutter mill, a hammer mill, a knife mill, a roller mill or a jet mill. A preferred aggregation diameter (specifically, median diameter and coarse particle diameter) of the secondary particles is as described above.

Since the hollow silica particles of the present invention have densified shell layer, the permeability of various solvents is low when the hollow silica particles are added to an organic solvent such as methyl ethyl ketone or N-methylpyrrolidone. Thus, the dispersibility in various solvents is good, and properties specific to hollow particles in the solvent can be maintained.

The hollow silica particles of the present invention can be used as various fillers, and can be particularly and suitably used as a filler in resin compositions used for production of an electronic substrate used in an electronic device such as a personal computer, a laptop, and a digital camera, and a communication device such as a smartphone and a game console. Specifically, the silica powder of the present invention is expected to be applied to a resin composition, a prepreg, a metal foil-clad laminate, a printed wiring board, a resin sheet, an adhesive layer, an adhesive film, a solder resist, a bump reflow, a rewiring insulating layer, a die bond material, a sealing material, an underfill, a mold underfill, a laminated inductor, and the like in order to achieve the low permittivity, the low transmission loss, the low moisture absorption, and the improved peel strength.

### EXAMPLE

Hereinafter, the present invention will be described with reference to examples, but the present invention is not limited thereto. In the following description, common components employ the same substance. Unless otherwise specified, “%” and “parts” represent “mass %” and “parts by mass”, respectively.

Examples 1 to 12 are working examples, and Examples 13 to 15 are comparative examples.

### Test Example 1

### Example 1

### Preparation of Emulsion

To 1250 g of pure water, 4 g of an EO-PO-EO block copolymer (Pluronic F68 manufactured by ADEKA Corporation) was added, followed by stirring until dissolution. To the obtained aqueous solution, 42 g of n-decane having 4 g of sorbitan acid monooleate (IONET S-80 manufactured by Sanyo Chemical Industries, Ltd.) dissolved was added, followed by stirring by a homogenizer manufactured by IKA until the entire liquid became uniform to prepare a crude emulsion.

The crude emulsion was emulsified under a pressure of 50 bar by using a high pressure emulsifier (LAB1000 manufactured by SMT CO., LTD.) to prepare a fine emulsion having an emulsion diameter of 1 μm.

### “Emulsion Aging”

The obtained fine emulsion was allowed to stand at 40° C. for 12 hours to obtain an aged emulsion.

### “First-stage Shell Formation”

To 1,300 g of the obtained emulsion after aging, 23 g of a diluted sodium silicate aqueous solution (SiO₂ concentration of 10.4 mass %, Na₂O concentration of 3.6 mass %) and 2 M hydrochloric acid were added so as to have a pH of 2, followed by thoroughly stirring while maintaining at 30° C.

While the liquid was stirred well, 1 M sodium hydroxide aqueous solution was dropped slowly to the liquid so that the pH became 6, thereby obtaining an oil core-silica shell particle dispersion. The obtained oil core-silica shell particle dispersion was maintained and aged.

### “Second-stage Shell Formation”

The entire oil core-silica shell particle dispersion obtained by the first-stage shell formation was heated to 70° C., and 1 M NaOH was added slowly with stirring to adjust the pH to 9.

Next, 330 g of a diluted sodium silicate aqueous solution (SiO₂ concentration of 10.4 mass %, Na₂O concentration of 3.6 mass %) was gradually added together with 0.5 M hydrochloric acid so as to have the pH of 9.

The obtained suspension was maintained at 80° C. for 1 day and then cooled to room temperature to obtain a hollow silica precursor dispersion.

### “Filtration, Washing, Drying, and Baking”

The entire hollow silica precursor dispersion was neutralized with 2 M hydrochloric acid so as to have a pH of 2, and then filtered with quantitative filter paper 5C. Thereafter, 350 ml of ion-exchanged water at 80° C. was added thereto, followed by filtration under pressure again to wash a hollow silica cake.

A cake obtained after the filtration was dried in a nitrogen atmosphere at 100° C. for 1 hour and then at 400° C. for 2 hours (temperature increase rate of 10° C./min) to remove organic components, thereby obtaining a hollow silica precursor.

The obtained hollow silica precursor was baked at 1,000° C. for 1 hour (temperature increase rate of 10° C./min) to bake a shell, thereby obtaining hollow silica baked particles.

### “Surface Treatment”

To a 200 ml glass beaker, 10 g of the hollow silica baked particles, 150 ml of isopropanol, and 0.1 g of vinyltrimethoxysilane were added, followed by refluxing at 100° C. for 1 hour. Thereafter, the obtained mixture was filtered under reduced pressure using a hydrophobic PTFE membrane filter, washed with 20 ml of isopropanol, and vacuum-dried for 2 hours with a vacuum dryer having a temperature adjusted to 150° C. to obtain surface-treated hollow silica particles.

### “Evaluation”

### 1. Density Measurement Using Dry Pycnometer

The density was measured using a dry pycnometer (AccuPyc II 1340 manufactured by Micromeritics Instrument Corporation). Measurement conditions were as follows. The results are shown in Table 1.
Sample cell: 10 cm³ cell
Sample weight: 1.0 g
Measurement gas: helium or argon
Number of times of purge: 10 times
Purge processing filling pressure: 135 kPag
Number of cycles: 10 times
Cycle filling pressure: 135 kPag
Rate at which pressure equilibrium is terminated: 0.05 kPag/min
   2. Sphericity and Proportion of Particles Having Particle Diameter within Average Primary Particle Diameter ±40%

The FIGURE shows a scanning electron microscopic image (SEM image) of the hollow silica particles obtained in Example 1. The SEM image was observed at an acceleration voltage of 5 kV using S4800 manufactured by Hitachi High-Tech Corporation.

For any 100 particles from the FIGURE, a diameter (DL) of each circumscribed circle and a diameter (DS) of each inscribed circle were measured, and the sphericity was determined from an average value obtained by calculating a ratio (DS/DL) of the diameter (DS) of the inscribed circle to the diameter (DL) of the circumscribed circle. In addition, primary particle diameters of any 100 particles were measured, and a proportion of particles having a particle diameter within the average primary particle diameter ±40% was determined from a distribution obtained by gathering the primary particle diameters. 3. Median Diameter (D50) and Coarse Particle Diameter (D90)

The obtained hollow silica particles (secondary particles) were measured by a diffraction/scattering particle distribution analyzer (MT 3300) manufactured by MicrotracBEL Corp., and the median (median diameter, D50) and the coarse particle diameter (90% diameter, D90) of the particle distribution (diameter) were measured. The measurement was performed twice, and an average value was determined. The results are shown in Table 1.

### 4. Specific Surface Area

The hollow silica particles were dried under reduced pressure at 230° C. to completely remove water, thereby obtaining a sample. Regarding the sample, the specific surface area was measured by a multi-point BET method using a nitrogen gas in “TriStar II”, which is an automatic specific surface area and pore distribution measurement device manufactured by Micromeritics Instrument Corporation. The results are shown in Table 1.

### 5. Concentration of Metal M (M=Li, Na, K, Rb, Cs, Mg, Ca, Sr, Ba)

Perchloric acid and hydrofluoric acid were added to the spherical hollow silica particles, and the obtained mixture was ignited to remove silicon as a main component, followed by measuring with ICP-AES (inductively coupled plasma-atomic emission spectroscopy) using ICPE-9000 (manufactured by SHIMADZU CORPORATION). According to the measurement, Na, K, Mg, and Ca were detected as the metal M. A total amount of the metal M is shown in Table 1.

### 6. Viscosity

A kneaded product obtained by mixing 6 parts by mass of a boiled linseed oil and (6×A/2.2) parts by mass of the hollow silica particles, where A (g/cm³) was a particle density determined by density measurement with a dry pycnometer using argon gas, and kneading a resulting mixture at 2,000 rpm for 3 minutes was measured for 30 seconds at a shear rate of 1 s⁻¹ using a rotary rheometer to determine a viscosity at 30 seconds. The results are shown in Table 1.

### 7. Q3/Q4

A CP/MAS probe having a diameter of 7.5 mm was attached to a 400 MHz nuclear magnetic resonance apparatus, an observation nucleus was set to ²⁹Si, and measurement was performed by a DD/MAS method. The measurement conditions were as follows: a ²⁹Si resonance frequency of 79.43 MHz, a ²⁹Si 90° pulse width of 5 μs, a 1H resonance frequency of 399.84 MHz, a 1H decoupling frequency of 50 kHz, a MAS rotation speed of 4 kHz, a spectrum width of 30.49 kHz, and a measurement temperature of 23° C. In the data analysis, for each peak of a spectrum after Fourier transform, optimization calculation was performed by a nonlinear least squares method using a center position, a height, and a half width of a peak shape created by mixing a Lorentz waveform and a Gaussian waveform as variable parameters. For the four structural units Q1, Q2, Q3, and Q4, the molar ratio of Q3 and Q4 was calculated from the determined content of Q1, content of Q2, content of Q3, and content of Q4. The results are shown in Table 1.

### 8. Relative Permittivity and Dielectric Loss Tangent

The relative permittivity and the dielectric loss tangent were measured by a perturbation resonator method using a dedicated device (vector network analyzer E5063A, manufactured by KEYCOM Corp.) at a test frequency of 1 GHz, a test temperature of about 24° C., a humidity of about 45%, and three times of measurement.

Specifically, the hollow silica particles were vacuum-dried at 150° C., and filled into a cylinder made of PTFE while sufficiently tapping the powder. The relative permittivity was measured for each container, and then the relative permittivity and the dielectric loss tangent of the powder were converted using the logarithmic mixing rule. The results are shown in Table 1.

### Example 2

Example 2 was carried out under the same conditions as in Example 1 except that the amount of the EO-PO-EO block copolymer (“Pluronic F68” manufactured by ADEKA Corporation) was changed to 2 g, and the amount of sorbitan acid monooleate (IONET S-80 manufactured by Sanyo Chemical Industries, Ltd.) was changed to 2 g.

### Example 3

Example 3 was carried out under the same conditions as in Example 1 except that the amount of EO-PO-EO block copolymer (“Pluronic F68” manufactured by ADEKA Corporation) was changed to 10 g, and emulsification was carried out under a pressure of 100 bar without using the sorbitan acid monooleate (IONET S-80 manufactured by Sanyo Chemical Industries, Ltd.).

### Example 4

Example 4 was carried out under the same conditions as in Example 1 except that the obtained hollow silica precursor was baked at 1,100° C. for 1 hour (temperature increase rate of 10° C./min).

### Example 5

Example 5 was carried out under the same conditions as in Example 1 except that the obtained hollow silica precursor was baked at 800° C. for 1 hour (temperature increase rate of 10° C./min).

### Example 6

Example 6 was carried out under the same conditions as in Example 1 except that the obtained hollow silica precursor was baked at 700° C. for 1 hour (temperature increase rate of 10° C./min).

### Example 7

Example 7 was carried out under the same conditions as in Example 1 except that 350 ml of tap water was added instead of the ion-exchanged water, followed by filtration under pressure again to wash a hollow silica cake.

### Example 8

Example 8 was carried out under the same conditions as in Example 1 except that the surface treatment was not carried out.

### Example 9

Example 9 was carried out under the same conditions as in Example 1 except that the obtained fine emulsion was allowed to stand at 80° C. for 4 hours to perform aging.

### Example 10

Example 10 was carried out under the same conditions as in Example 1 except that the amount of the EO-PO-EO block copolymer (“Pluronic F68” manufactured by ADEKA Corporation) was changed to 3 g, and the amount of sorbitan acid monooleate (IONET S-80 manufactured by Sanyo Chemical Industries, Ltd.) was changed to 5 g.

### Example 11

Example 11 was carried out under the same conditions as in Example 1 except that the first-stage shell formation and the second-stage shell formation were performed as follows.

### “First-stage Shell Formation”

To 1300 g of the obtained fine emulsion, 0.90 g of methyl orthosilicate and 2 M hydrochloric acid were added so as to have a pH of 2, followed by thoroughly stirring while maintaining at 30° C.

While the liquid was stirred well, 1 M ammonia water was dropped slowly to the liquid so that the pH became 6, thereby obtaining an oil core-silica shell particle dispersion. The obtained oil core-silica shell particle dispersion was maintained and aged.

### Second-Stage Shell Formation

The entire oil core-silica shell particle dispersion obtained by the first-stage shell formation was heated to 70° C., and 5 M ammonia water was added slowly with stirring to adjust the pH to 9.

Next, 13 g of diluted methyl orthosilicate was gradually added together with 0.5 M hydrochloric acid so as to have a pH of 9.

The obtained suspension was maintained at 70° C. for 2 days and then slowly cooled to room temperature to obtain a hollow silica precursor dispersion.

### Example 12

SO-C2 (silica produced by vaporized metal combustion method that has a median diameter of 0.5 μm, or solid silica, manufactured by Admatex Co., Ltd.) was dispersed in water to obtain a 3 mass % aqueous dispersion. The obtained mixture was dried at 120° C. with a spray dryer (mini spray dryer B290, manufactured by Nihon BUCHI K.K.) to obtain precursor silica having a median diameter of 3 μm. The precursor silica was baked at 1,300° C. to obtain hollow silica particles having a space portion inside.

### Example 13

The hollow silica precursor obtained in Example 1 was used as it was without being baked.

### Example 14

SO-C2 (silica produced by vaporized metal combustion method that has a median diameter of 0.5 μm, or solid silica, manufactured by Admatex Co., Ltd.) was used as it was.

### Example 15

iM16K (glass balloon having a median diameter of 18 μm, manufactured by 3M Company) was used as it was.

The results are summarized in Table 1.

TABLE 1

| | | | | | | Proportion of | |
|---|---|---|---|---|---|---|---|
| | | | | BET | | particles having | |
| | Ar density × | | | specific | | particle diameter | |
| | BET specific | Ar | He | surface | | within average | |
| | surface area | density | density | area | | primary particle | |
| | m²/cm³ | g/cm³ | g/cm³ | m²/g | Sphericity | diameter ± 40% | |
| Example 1 | 7.8 | 0.65 | 2.15 | 12 | 0.95 | 50% | |
| Example 2 | 2.7 | 0.45 | 2.15 | 6 | 0.95 | 60% | |
| Example 3 | 60 | 1.00 | 2.15 | 60 | 0.95 | 45% | |
| Example 4 | 15 | 1.5 | 2.25 | 10 | 0.95 | 50% | |
| Example 5 | 35.2 | 0.80 | 2.05 | 44 | 0.95 | 50% | |
| Example 6 | 110.4 | 1.20 | 1.95 | 92 | 0.95 | 50% | |
| Example 7 | 9.75 | 0.65 | 2.15 | 15 | 0.95 | 50% | |
| Example 8 | 7.8 | 0.65 | 2.15 | 12 | 0.95 | 50% | |
| Example 9 | 12.6 | 0.90 | 2.15 | 14 | 0.95 | 35% | |
| Example 10 | 7.2 | 0.60 | 2.15 | 12 | 0.95 | 75% | |
| Example 11 | 28.8 | 1.20 | 2.15 | 24 | 0.95 | 50% | |
| Example 12 | 9.75 | 1.95 | 2.28 | 5 | 0.8 | 50% | |
| Example 13 | 270 | 1.50 | 2.15 | 180 | 0.95 | 50% | |
| Example 14 | 11.25 | 2.25 | 2.28 | 5 | 0.8 | 50% | |
| Example 15 | 0.64 | 0.4 | 0.45 | 1.6 | 0.9 | 40% | |
| | | | Total | | NMR | | Dielectric |
| | | | amount of | Oil | Q3/Q4 | Relative | loss |
| | D50 | D90 | metal M | viscosity | mol %/ | permittivity | tangent |
| | μm | μm | ppm | mPa · s | mol % | Value at 1 GHz | |
| Example 1 | 1 | 3 | 500 | 2,000 | 20% | 1.85 | 0.0020 |
| Example 2 | 2 | 3 | 500 | 1,300 | 20% | 1.55 | 0.0015 |
| Example 3 | 7 | 24 | 1,200 | 9,000 | 20% | 2.20 | 0.0100 |
| Example 4 | 9 | 30 | 500 | 1,800 | 20% | 3.00 | 0.0050 |
| Example 5 | 1 | 3 | 500 | 3,100 | 25% | 2.10 | 0.0200 |
| Example 6 | 1 | 3 | 500 | 4,000 | 40% | 2.30 | 0.0400 |
| Example 7 | 5 | 12 | 8,000 | 2,500 | 20% | 1.85 | 0.0040 |
| Example 8 | 1 | 3 | 500 | 2,500 | 20% | 1.85 | 0.0060 |
| Example 9 | 1.5 | 9 | 500 | 3,200 | 20% | 2.10 | 0.0050 |
| Example 10 | 1 | 7 | 500 | 1,700 | 20% | 1.75 | 0.0018 |
| Example 11 | 1 | 3 | 50 | 2,000 | 5% | 2.30 | 0.0060 |
| Example 12 | 5 | 25 | 300 | 3,500 | 0% | 3.50 | 0.0025 |
| Example 13 | 1 | 3 | 500 | 12,000 | 60% | 3.00 | 0.0350 |
| Example 14 | 0.5 | 10 | 300 | 3,500 | 0% | 4.00 | 0.0030 |
| Example 15 | 17 | 30 | 10,000 | 1,000 | 30% | 1.80 | 0.0800 |

As shown in Table 1, it was found that in Examples 1 to 12, in the density measurement using the dry pycnometer, in the case where helium was used as the measurement gas, the density was 1.95 g/cm³ to 2.28 g/cm³, a value equivalent to the true density of silica was obtained, and the helium gas passes through the shell and enters an inner cavity of the hollow silica. On the other hand, it is considered that in the case where the argon gas was used, a value smaller than the value measured by the helium pycnometer method was obtained in any of the examples, the speed at which the argon gas passed through the shell was slow, and thus a density of particles having no the inner cavity of the hollow silica was obtained.

In addition, while the relative permittivity at 1 GHz was small in Examples 1 to 12, the relative permittivity at 1 GHz was large in Example 14, and the desired effect of the present invention could not be obtained. This is considered to be because the presence of the spaces inside the silica particles of Examples 1 to 12 decreased the relative permittivity due to the air content. In Examples 13 and 15, the dielectric loss tangent at 1 GHz was large, and the desired effect of the present invention could not be obtained. This is considered to be because the hollow silica in Example 13 had a large value of Ar density×BET specific surface area, and further had a large value of Q3/Q4, and the number of silanol groups included per silica was likely to increase, and thus the dielectric loss tangent was deteriorated. In addition, in Example 15, since a glass balloon was used instead of silica, a large amount of alkali components and a large number of silanol groups were likely to be generated. Therefore, it is considered that the dielectric loss tangent was deteriorated.

### Test Example 2

### Preparation of Evaluation Sample A (Resin Film)

Resin films were prepared using the particle powder of Examples 1, 2, 14, and 15.

In 13 parts by mass of methyl ethyl ketone (MEK), 25 parts by mass of a biphenyl type epoxy resin (epoxy equivalent: 276, “NC-3000” produced by Nippon Kayaku Co., Ltd.) were dissolved by heating while stirring. The obtained mixture was cooled to room temperature, and mixed with 32 parts by mass of an active ester-based curing agent (“HP 8000-65T” manufactured by DIC Corporation, active group equivalent: 223, toluene solution containing 65 mass % of non-volatile components), followed by kneading at 2,000 rpm for 5 minutes using a planetary centrifugal stirrer, Awatori Rentaro (manufactured by THINKY CORPORATION), mixing 0.9 parts by mass of 4-dimethylaminopyridine (DMAP) and 1.6 parts by mass of 2-ethyl-4-methyl imidazole (“2E4MZ”, manufactured by Shikoku Chemicals Corporation) as curing accelerators, and kneading at 2,000 rpm for 5 minutes with Awatori Rentaro. Thereafter, (6×A/2.2) parts by mass of the particle powder was mixed therein, followed by kneading at 2,000 rpm for 5 minutes with Awatori Rentaro, where A (g/cm3) was a particle density determined by density measurement with a dry pycnometer using argon gas.

Next, a transparent polyethylene terephthalate (PET) film (“PET5011 550” manufactured by Lintec Corporation, thickness: 50 um) which was subjected to a mold release treatment was prepared. The obtained varnish was applied to a release-treated surface of the PET film using an applicator so as to have a thickness after drying of 40 μm, followed by drying in a gear oven at 100° C. for 10 minutes, and then cutting to prepare an uncured laminated film including an uncured resin film (B-stage film) of 200 mm in length×200 mm in width×40 μm in thickness.

The obtained uncured laminated film was heated in a gear oven at 190° C. for 90 minutes to cure the uncured resin film, thereby preparing a resin film.

### Preparation of Evaluation Sample B (Laminate)

### (1) Laminating Step

A single-sided roughened copper foil (F0-WS, thickness of 18 μm, surface roughness Rz=1.2 μm, manufactured by Furukawa Electric Co., Ltd.) was prepared. The uncured laminated film prepared as described above was laminated on the copper foil using a “batch type vacuum laminator MVLP-500-IIA” manufactured by MEIKI CO., LTD. such that a surface of the uncured resin film (B-stage film) faced a roughened copper foil surface, thereby obtaining a laminated structure including the copper foil/B-stage film/PET film. The lamination was performed under the following conditions: pressure reduction was performed for 30 seconds to set a atmospheric pressure to 13 hPa or less, and then pressing was performed for 30 seconds at 100° C. under a pressure of 0.8 MPa.

### (2) Film Peeling Step

The PET film of the laminated structure was peeled off.

### (3) Curing Step

A laminated plate was placed in a gear oven having an internal temperature of 180° C. for 30 minutes to cure the B-stage film, thereby forming an insulating layer.

### “Evaluation”

### 1. Evaluation of Relative Permittivity and Dielectric Loss Tangent

The relative permittivity and the dielectric loss tangent (measured frequency: 10 GHz) of the obtained evaluation sample A were measured with a vertical split post dielectric resonator (manufactured by Agilent Technologies Japan, Ltd.). The results are shown in Table 2.

### 2. Measurement of Average Coefficient of Linear Expansion

The evaluation sample A was cut into a size of 3 mm×25 mm. The sample was heated at a load of 5 N and a temperature increase rate of 2° C./min using a thermomechanical analyzer (“TMA-60” manufactured by SHIMADZU CORPORATION). Then, the dimensional change of the sample from 30° C. to 150° C. was measured, and the dimensional change of the long side was divided by the temperature to determine the average coefficient of linear expansion (ppm/° C.). The results are shown in Table 2.

### 3. Measurement of Peel Strength

For the evaluation sample B, a cut was made in a strip shape on the copper foil side so as to have a width of 1 cm. The substrate was set in a 90° peel tester, a copper-plated end with the cut was picked up with a gripper, the copper plating was peeled by 20 mm, and peel strength (N/cm) was measured. The results are shown in Table 2.

TABLE 2

| | Ar density × | | BET | | | Average | |
|---|---|---|---|---|---|---|---|
| | BET specific | | specific | | Dielectric | coefficient | |
| | surface | Ar | surface | Relative | loss | of linear | Peel |
| | area | density | area | permittivity | tangent | expansion | strength |
| | m²/cm³ | g/cm³ | m²/g | 10 GHz | | ppm/° C. | N/mm |
| Example 1 | 7.8 | 0.65 | 12 | 2.75 | 0.0065 | 25 | 55 |
| Example 2 | 2.7 | 0.45 | 6 | 2.59 | 0.0060 | 25 | 75 |
| Example 14 | 11.25 | 2.25 | 5 | 3.3 | 0.0075 | 25 | 15 |
| Example 15 | 0.64 | 0.4 | 1.6 | 2.64 | 0.0120 | 30 | 75 |

From the results of Table 2, it was found that, in the case where the hollow silica particles of Examples 1 and 2 in which the product (A×B) of the Ar density and the BET specific surface area was small were used, both the relative permittivity and the dielectric loss tangent were good, and the average coefficient of linear expansion was small. Since the excellent low relative permittivity and low dielectric loss tangent were also exhibited in the resin composition, it was confirmed that the methyl ethyl ketone as a solvent was difficult to penetrate, and it was found that solvents such as N-methylpyrrolidone, cyclohexanone, and methyl isobutyl ketone having molecules larger than those of methyl ethyl ketone were difficult to penetrate. When the solid silica was used as in Example 14, the relative permittivity was high and the peel strength deteriorated. In addition, it was found that when a borosilicate silicate glass balloon was used as in Example 15, the dielectric loss tangent was high because the surface silanol was large due to the alkali content included in the borosilicate silicate glass, and the average coefficient of linear expansion was also high because a thermal expansion coefficient of the borosilicate silicate glass was larger than that of silica.

Although the present invention has been described in detail with reference to specific embodiments, it is apparent to those skilled in the art that various changes and modifications can be made without departing from the spirit and scope of the present invention. The present application is based on a Japanese Patent Application (No. 2021-194371) filed on Nov. 30, 2021, the contents of which are incorporated herein by reference.

1. Hollow silica particles each comprising a shell layer that comprises silica and having a space portion inside the shell layer, wherein
when A (g/cm³) is a particle density determined by density measurement with a dry pycnometer using argon gas and B (m²/g) is a BET specific surface area, the hollow silica particles have a product (A×B) of the particle density and the BET specific surface area of 1 m²/cm³ to 120 m²/cm³.

2. The hollow silica particles according to claim 1, having the particle density determined by density measurement with a dry pycnometer using argon gas of 0.35 g/cm3 to 2.00 g/cm³.

3. The hollow silica particles according to claim 1, having a particle density determined by density measurement with a dry pycnometer using helium gas of 2.00 g/cm³ to 2.35 g/cm³.

4. The hollow silica particles according to claim 1, having an average primary particle diameter of 50 nm to 10 μm.

5. The hollow silica particles according to claim 1, wherein 35% or more of all primary particles have a particle diameter within an average primary particle diameter ±40%.

6. The hollow silica particles according to claim 1, having the BET specific surface area of 1 m²/g to 100 m²/g.

7. The hollow silica particles according to claim 1, having a sphericity of 0.75 to 1.0.

8. The hollow silica particles according to claim 1, having a median diameter (D50) of secondary particles of 0.1 μm to 10 μm.

9. The hollow silica particles according to claim 1, having a coarse particle diameter (D90) of secondary particles of 1 μm to 30 μm.

10. The hollow silica particles according to claim 1, comprising one or more kinds of metal M selected from the group consisting of Li, Na, K, Rb, Cs, Mg, Ca, Sr, and Ba, and having a total concentration of the metal M of 50 ppm by mass or more and 1 mass % or less.

11. The hollow silica particles according to claim 1, wherein a viscosity of a kneaded product comprising the hollow silica particles as measured by the following measurement method is 10,000 mPa·s or less,
the measuring method:
a kneaded product obtained by mixing 6 parts by mass of a boiled linseed oil and (6×A/2.2) parts by mass of the hollow silica particles, where A (g/cm³) is a particle density determined by density measurement with a dry pycnometer using argon gas, and kneading a resulting mixture at 2,000 rpm for 3 minutes is measured for 30 seconds at a shear rate of 1 s⁻¹ using a rotary rheometer to determine a viscosity at 30 seconds.

12. The hollow silica particles according to claim 1, having a molar ratio (Q3/Q4) of a Q3 structure to a Q4 structure as measured by solid ²⁹Si-DD/MAS-NMR of 2% to 40%, the Q3 structure being a structure having one OH group derived from a silanol group and the Q4 structure being a structure having no OH group derived from the silanol group.

13. A method for producing the hollow silica particles according to claim 1, the method comprising:
preparing an oil-in-water emulsion comprising an aqueous phase, an oil phase, and a surfactant;
leaving the oil-in-water emulsion to stand for 0.5 hours to 240 hours to obtain a hollow silica precursor in which a shell layer comprising silica is formed on an outer periphery of a core in the oil-in-water emulsion; and
removing the core from the hollow silica precursor, followed by performing a heat treatment.

14. The method for producing hollow silica particles according to claim 13, the method further comprising: subjecting particles after the heat treatment to a surface treatment with a silane coupling agent.

15. The method for producing hollow silica particles according to claim 13, the method further comprising: adding a silica raw material to the oil-in-water emulsion.

16. The method for producing hollow silica particles according to claim 15, wherein sodium silicate is used as a silica source.

17. A resin composition comprising 5 mass % to 70 mass % of the hollow silica particles according to claim 1.

18. A slurry composition comprising 1 mass % to 40 mass % of the hollow silica particles according to claim 1.
